(19) United States
(12) Patent Application Publication
(10) Pub. No.: US 2020/0379645 A1
(43) Pub. Date: Dec. 3, 2020

(54) COMPUTING DEVICE OPERATIONAL CONTROL USING MONITORED ENERGY STORAGE DEVICE HEALTH PARAMETERS

(71) Applicant: Microsoft Technology Licensing, LLC, Redmond, WA (US)

(72) Inventors: Rameez KAZI, Bellevue, WA (US); Tracy Alan COREY, Kirkland, WA (US); Neeraj LADKANI, Bothell, WA (US); Tom Long NGUYEN, Auburn, WA (US); Jeffrey Matthew SHUEY, Bothell, WA (US)

(21) Appl. No.: 16/456,054

(22) Filed: Jun. 28, 2019

Related U.S. Application Data
(60) Provisional application No. 62/855,428, filed on May 31, 2019.

(51) Int. Cl. G06F 3/06; G06F 1/28; G06F 13/16

(52) U.S. Cl. CPC G06F 3/065; G06F 1/28; G06F 3/0619; G06F 13/1668; G06F 3/0659; G06F 3/068; G06F 3/0653

(57) ABSTRACT

One or more energy storage device health parameters are monitored in a computing device. Backup of a volatile portion of a memory device such as a non-volatile dual in-line memory module (NVDIMM) is initiated based on the one or more monitored energy storage device parameters satisfying a predetermined operational condition. Example energy storage device health parameters include a State of Health (SOH) parameter and a State of Charge (SOC) parameter.

### CROSS REFERENCE TO RELATED APPLICATIONS

This application claims the benefit of U.S. Provisional Patent App. No. 62/855,428, entitled “Energy Storage Health Indication,” and filed on May 31, 2019, which is specifically incorporated by reference for all that it discloses and teaches.

### BACKGROUND

Upon detection of AC power loss by a baseboard management controller (BMC) from a power supply unit (PSU), a computing device may prepare for a standard backup process in which volatile memory contents are copied to non-volatile memory. Upon reestablishment of power, the contents may be reloaded from the non-volatile memory back into volatile memory so that users may quickly start where they left off before power loss.

### SUMMARY

The described technology provides control methods and systems that allow a computing device to monitor one or more energy storage device (e.g., battery) health or operational parameters and take appropriate system actions based on the monitored health parameters to yield reliable persistent memory (e.g., NVDIMM) backup operations among other tasks. In one implementation, a backup operation of a volatile memory device on a computing device is controlled. One or more health parameters of an energy storage module in the computing device are monitored and then it is determined whether the one or more operational parameters satisfy a predetermined operational condition. The backup operation is executed when the one or more health parameters are determined to satisfy the predetermined operational condition and execution of the backup operation is inhibited when the one or more health parameters are determined to not satisfy the predetermined operational condition. Example battery health parameters include a State of Health (SOH) parameter and a State of Charge (SOC) parameter.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment providing energy storage device health parameter-based control of operations in a computing device.

FIG. 2 illustrates example base management controller (BMC) components of a BMC for use in the computing environment of FIG. 1.

FIG. 3 illustrates an example flow diagram of a method of monitoring energy storage device health parameters and implementing computing operations based on the monitored health parameters during a boot operation of a computing device.

FIG. 4 illustrates an example flow diagram of a method of monitoring energy storage device health parameters and implementing computing operations based on the monitored health parameters during operating system (OS) runtime operation of a computing device.

FIG. 5 illustrates an exemplary computing device for implementing the features and operations of the described technology.

### DETAILED DESCRIPTIONS

Upon detection of AC power loss by a baseboard management controller (BMC) from a power supply unit (PSU), a computing device prepares for a standard backup process in which volatile memory contents are copied to non-volatile memory. Upon reestablishment of power, the contents are reloaded from the non-volatile memory back into volatile memory so that users may quickly start where they left off before power loss.

Backing up of information (e.g., data, instructions) from volatile to non-volatile storage during AC power loss as part of the standard backup process requires use of at least one energy storage device (e.g., battery). Each backup process requires a particular amount of energy from the energy storage device that may vary based on the size and type of the volatile memory, the amount of information to be backed up, and the like. Degradation of an energy storage device can make determining whether or not a current capacity of the energy storage device can satisfy the energy requirements of a backup process increasingly difficult. For example, energy storage devices degrade through accelerated charge cycles, ambient conditions, high and/or low voltage or temperate during storage, and the like. While engineers can attempt to compensate for such uncertainties by building in margins for error, what results is often larger than needed energy storage devices and increased usage of computing device real estate.

An operating system (OS) can take certain actions based on a “State of Charge” (SOC) parameter of an energy storage device, where a SOC is a figure of merit for the charge of the battery. Representative actions include adjusting fan speeds, turning lights down, and the like. However, such systems can fail to account for environmental conditions such as size and type of memory, quantity of information to be backed up, and energy storage device health as part of backup procedures. For example, an energy storage device charged to 100% whose health has degraded has a reduced capacity (where “capacity” is the amount of energy (e.g., in joules) that can currently be extracted from an energy storage device) as compared to a brand-new energy storage device charged to 100%. Conversely, an energy storage device charged to 100% whose health has degraded may nevertheless have an increased capacity as compared to a brand-new energy storage device that is only charged to 10%. For example, an energy storage device having an SOH parameter of 90% and an SOC parameter of 30% may have a different capacity (i.e., amount of energy that currently may be extracted from the energy storage device) than when the energy storage device has an SOH parameter of 50% and an SOC parameter of 95%.

Such systems also fail to analyze energy storage device operational (e.g., health) parameters for generating recommended actions (e.g., repair/replacement of energy storage device), taking other computing device actions (e.g., inhibiting system reboots until energy storage devices have a minimum capacity), and the like.

Implementations described utilize energy storage device health parameters such as SOC parameters and “State of Health” (SOH) parameters in conjunction with each other to support intelligent backup control for a volatile memory portion of a memory device (e.g., NVDIMM or non-volatile dual in-line memory module), among other things. An SOH parameter is a “measurement” that reflects the general condition of an energy storage device and its ability to deliver the specified performance compared with a fresh energy storage device of the same type/model. Generation of an SOH parameter takes into account such factors as charge acceptance, internal resistance, voltage and self-discharge. In other words, an SOH parameter provides an indication of how much “lifetime energy throughput” of the device has been used and how much is still available. As an example in the case where an energy storage device is equivalent to a gas can, the SOH parameter would be equivalent to the empty volume of the can (which shrinks over time) and the SOC parameter would be equivalent to a percentage of the current empty volume of the can that is currently filled with fuel. For example, an energy storage device having an SOH parameter of 90% and an SOC parameter of 30% may have a different capacity (i.e., amount of energy that currently may be extracted from the energy storage device) than when the energy storage device has an SOH parameter of 50% and an SOC parameter of 95%.

The disclosed technologies analyze energy storage device health parameters (such as SOC and SOH parameters) to determine a current capacity of an energy storage device, make determinations as to whether the current capacity can support energy requirements of computing system operations such as backups and the like, and take corresponding actions based on the results of the determinations. The described solutions utilize a controller (e.g., baseboard management controller (BMC)) to restrict enabling of backups within a computing device to when the energy storage device health supports such backups. The disclosed solutions can also provide active notifications through an event log (e.g., System Event Log (SEL)) and/or the OS when system servicing is necessary to replace an unhealthy energy storage device.

Beyond the benefits of ensuring backups in normal situations, the described technology can improve system and datacenter monitoring interactions at a broader scale. As an energy storage device ages and if the energy storage device was accelerated beyond design perimeters of the system, a user can use the described technology to schedule repairs of the energy storage device before hard failure occurs. For example, energy storage device parameters can be polled for on a regular basis (e.g., every second or two) and analytics conducted to make such determinations in a predictive manner. Furthermore, by understanding how an energy storage device has aged, a computing device can utilize such device for a longer period than projected, thus extending the usable life of the computing device.

During system power-on and before enabling the mains power rails, a BMC of a computing device may check and conduct analytics on the one or more energy storage device health parameters to determine whether the energy storage device is in a known good state capable of successfully completing a backup in case of AC power loss. In one arrangement, a basic input/output system (BIOS) unit of the computing device is configured to obtain volatile memory parameters (e.g., size, etc.) which may be used to determine whether the current energy storage device capacity can support backup of such volatile memory. The computing device may be allowed to boot to the OS when it is determined the energy storage device can support backups and may be required to wait to boot to the OS until it is determined the energy storage device can support backups (which may occur after continued charging of the energy storage device by any appropriate power supply).

In the case where the computing device is already operating in the OS, the computing device may continue monitoring the energy storage device health parameters as described herein and record the same in any appropriate manner. For example, upon determining that the one or more energy storage device health parameters satisfy a predetermined operational condition (e.g., level(s) indicating that a current capacity of the energy storage device is near or below that required to successfully achieve a backup), alerts are generated and events are logged indicative of such satisfied conditions to allow for corrective actions to be taken (e.g., repair or replacement of the energy storage device). Furthermore, upon a need of a backup (e.g., for maintenance, upon power loss, etc.) and determining that the one or more energy storage device health parameters satisfy the predetermined operational condition (e.g., level(s) indicating that a current capacity of the energy storage device is below that required to successfully achieve a backup), execution of the backup is inhibited; otherwise, execution of the backup is allowed.

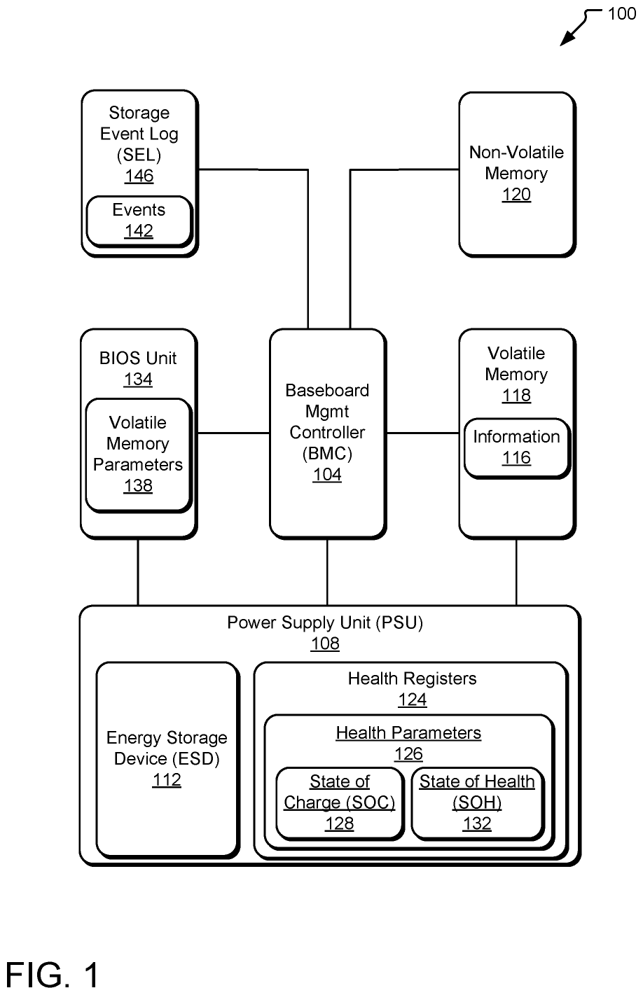

FIG. 1 is a block diagram of an example computing environment or system 100 providing energy storage device health parameter-based control of operational parameters of a computing device. As will be discussed in more detail herein, the disclosed environment 100 advantageously increases the occurrence of successful volatile memory backups, facilitates timely replacement of degraded energy storage devices, and monitors energy storage device health for future debugging operations.

A microcontroller or service processor such as a BMC 104 is broadly configured to obtain health parameters 126 regarding an energy storage device 112, determine one or more metrics regarding the energy storage device 112 based on the obtained health parameters 126, and trigger various types of actions based on the determined metrics in a manner that allows for intelligent control of such actions and the like. For example, upon generating metrics indicating that the energy storage device 112 has a current capacity that would allow for a backup of information 116 in volatile memory 118 to occur, the BMC 104 triggers a backup operation causing the information 116 to be copied from the volatile memory 118 to any appropriate non-volatile memory 120 (e.g., on-board flash or hard drive storage, cloud-based storage, and/or the like), logging of corresponding events 142 to a SEL 146, and/or the like.

A PSU 108 includes the energy storage device 112 and also includes (or at least has access to) one or more health registers 124 storing the one or more health parameters 126 (e.g., SOC parameters 128, SOH parameters 132, etc.) of the energy storage device 112. The health parameters 126 are generated in any appropriate manner and according to any appropriate frequency or event occurrence. For example, the one or more health parameters 126 can be generated on a percentage basis (e.g., where an SOH=40% means that 40% of the useful life the energy storage device 112 remains and an SOC=90% means that 90% of the 40% useful life is charged). In one arrangement, the one or more health parameters 126 are generated and stored in the one or more health registers every 0.1 seconds and maintained in the one or more health registers for any appropriate period of time.

The BMC 104 is configured to obtain the health parameters 126 in any appropriate manner. In one arrangement, the BMC 104 is to query (e.g., over an I2C bus or the like) the one or more health registers 124 for the health parameters 126 at any appropriate frequency such as every one second or the like. Additionally or alternatively, the BMC 104 is configured to query the one or more health registers 124 for the health parameters 126 upon receipt of a signal or alert from the PSU 108 that an AC power outage has occurred. Still further, the PSU 108 may be configured to automatically write events 142 to the SEL 146 upon one or more of the health parameters 126 reaching one or more particular levels whereupon the BMC 104 may receive automatic notifications of such events 142.

In addition to receiving health parameters 126 regarding the energy storage device 112, the BMC 104 is configured to obtain one or more volatile memory parameters 138 from the BIOS unit 134 regarding the volatile memory 118 for use in determining whether predetermined operational conditions have been satisfied, actions should be taken, and the like. For example, the volatile memory parameters 138 may include a capacity of the volatile memory 118 (e.g., in GB), a current amount of information stored in the volatile memory 118 (e.g., in GB) and a make and model of the volatile memory 118. In one arrangement, the volatile memory parameters 138 include any appropriate code (e.g., stock keeping unit (SKU)) that links the volatile memory with various attributes thereof.

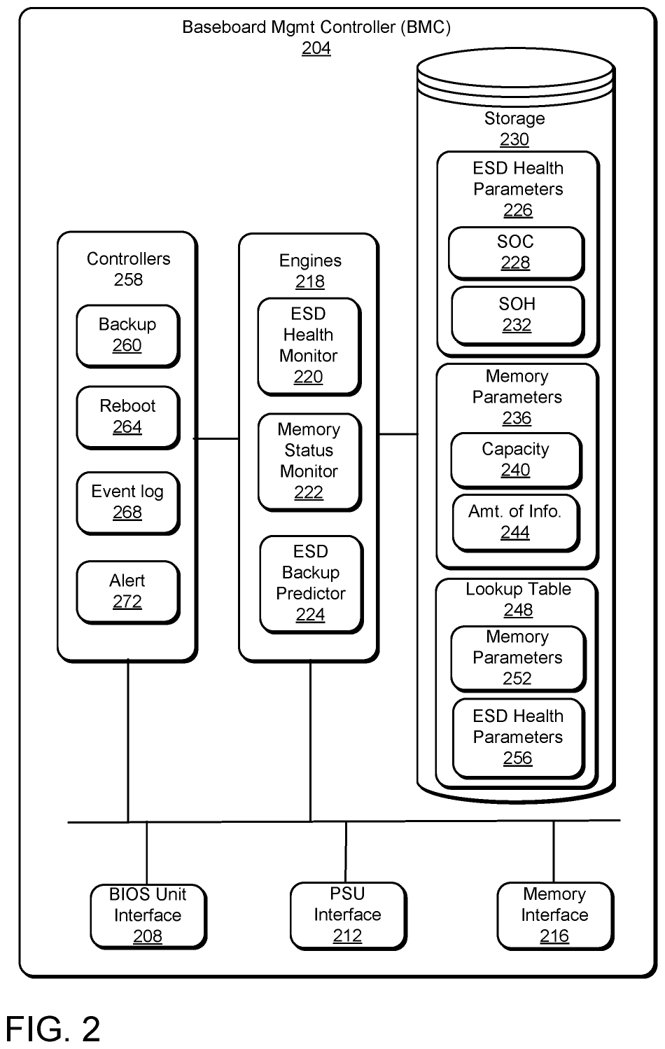

FIG. 2 presents a block diagram of a BMC 204 (e.g., BMC 104 of FIG. 1) and illustrates various components that facilitate the monitoring of energy storage device health levels and intelligent control of various actions in a computing device. The BMC 204 includes various interfaces such as a BIOS unit interface 208, a PSU unit interface 212, and a memory interface 216 for respectively communicating with the BIOS unit 134, the PSU 108, and the volatile and non-volatile memory 118, 120 of FIG. 1. The BMC 204 also includes one or more engines 218 broadly configured to obtain energy storage device health parameters 226 (e.g., from PSU 108 of FIG. 1) and trigger one or more controllers 258 to initiate various actions based on determined analytics.

As shown in FIG. 2, the one or more engines 218 maintain or at least have access to a database or storage 230 (e.g., any appropriate non-volatile memory) within which various types of data are maintained in any appropriate manner for use in implementing the disclosed technologies. For example, an energy storage device health monitor 220 obtains/receives one or more energy storage device health parameters 226 (e.g., SOC and SOH parameters 228, 232) and stores the same in one portion of the storage 230. As discussed herein, such energy storage device health parameters 226 are obtained on a regular basis (e.g., every one second or the like) and/or in response to particular occurrences (e.g., detection of AC power loss). As another example, a memory status monitor 222 obtains/receives various memory parameters 236 (e.g., capacity 240 of the volatile memory, an amount of information 244 stored on the volatile memory, etc.) and stores the same in another portion of the storage 230.

In a further portion of the storage, a lookup table 248 is stored that broadly correlates each of a plurality of sets of memory parameters 252 with a respective set of one or more energy storage device health parameters 256. Broadly, each set of one or more energy storage device health parameters 256 collectively represents at least a minimum energy storage device capacity (i.e., amount of energy that currently may be extracted from the energy storage device) needed to support a successful backup of information on volatile memory defined by the respective set of memory parameters 252 to non-volatile memory. For example, backing up 512 MB of data from the volatile memory to the non-volatile memory would require far less capacity from the energy storage device than would backing up 4 GB of data. In one implementation for each respective memory parameter set 252, the lookup table 248 further includes respective energy storage device health parameter sets 256 that respectively represent particular energy storage device capacity differences away from the minimum (e.g., such as 10% different, 20% different, etc.). The lookup table 248 may be generated based on information received from device manufactures and/or the like and loaded into the storage 230 at any appropriate time. In one arrangement, the lookup table may be updated at any appropriate time to modify/remove existing memory parameter sets 252/energy storage device health parameter sets 256 and/or to add new memory parameter sets 252/energy storage device health parameter sets 256.

Upon receiving an alert from the PSU regarding an AC power outage, an energy storage device backup predictor 224 utilizes the obtained memory parameters 236 (representing a current state of the volatile memory and information stored therein) as a key into the lookup table 248 to determine the particular one or more energy storage device health parameters 256 needed for the energy storage device to support a successful backup of the information on the volatile memory. The energy storage device backup predictor 224 then assesses whether the obtained energy storage device health parameters 226 satisfy a “predetermined operational condition”. In one arrangement, the predetermined operational condition is energy storage device health parameters that are equal to or greater than the respective energy storage device health parameter set 256 collectively representing the minimum energy storage device capacity needed to support a successful backup of information on volatile memory defined by the respective set of memory parameters 252 to non-volatile memory. In another arrangement, the predetermined operational condition is energy storage device health parameters that are equal to or greater than the respective energy storage device health parameter set 256 collectively representing a capacity that is a particular percentage greater than the minimum energy storage device capacity needed to support a successful backup of information on volatile memory defined by the respective set of memory parameters 252 to non-volatile memory.

In any case, the energy storage device backup predictor 224 then triggers a backup controller 260 to initiate a backup of information on the volatile memory to the non-volatile memory if the predetermined operational conditions are satisfied. If the predetermined operational conditions are not satisfied, the energy storage device backup predictor 224 trigger the backup controller 260 to not initiate a backup of information on the volatile memory to the non-volatile memory (or alternatively not trigger the backup controller 260 to initiate the backup). In some implementations, the energy storage device backup predictor 224 is configured to trigger an event log controller 268 to write events indicative of the predetermined operational condition being satisfied and/or not satisfied to the SEL (e.g., SEL 146) or the like.

In the above-discussed example, the trigger for the energy storage device backup predictor 224 to assess whether the predetermined operational condition was satisfied was detection of an AC power loss (e.g., upon receipt of a signal from the PSU). In another implementation, it may be desired to know whether the energy storage device can support a backup of information from volatile memory to non-volatile memory before initiation of a boot or reboot of a computing device. In this regard, the trigger for the energy storage device backup predictor 224 to assess whether the predetermined operational condition has been satisfied is receipt of a request to boot the OS into memory. The energy storage device backup predictor 224 then triggers a boot/reboot controller 264 to initiate a boot/reboot of the computing device if the predetermined operational conditions are satisfied. If the predetermined operational conditions are not satisfied, the energy storage device backup predictor 224 does not trigger the boot/reboot controller 264 to initiate the boot/reboot but continues to monitor subsequently obtained energy storage device health parameters 226 (e.g., after charging of the energy storage device) to assess whether the predetermined operational condition has been satisfied.

In a further implementation, the energy storage device backup predictor 224 is configured to continually monitor (e.g., during runtime operation of the computing device) obtained energy storage device health parameters 226, record events, and generate corresponding alerts when the capacity of the energy storage device has reached (e.g., fallen below, exceeded) one or more predefined levels. In other words, the energy storage device backup predictor 224 is configured to alert users of one or more predefined reductions in the usable life of the energy storage device to allow repairs and/or replacements of the energy storage device to be made before a power outage occurs, a boot request is received, and/or the like. In this implementation, for each respective memory parameter set 252, the lookup table 248 include a plurality of energy storage device health parameter sets 256, where each successive energy storage device health parameter set 256 represents a reduction (e.g., or increase) in the capacity of the energy storage device.

For example, the energy storage device backup predictor 224 is configured to continually (e.g., every one second, every five seconds, etc.) obtain energy storage device health parameters 226 and memory parameters 236, use the obtained memory parameters 236 as a key into the lookup table to identify a particular plurality of energy storage device health parameter sets 256, and then determine when the obtained energy storage device health parameters 226 meet or match one of the particular plurality of energy storage device health parameter sets 256. Upon making such a determination (e.g., that a predetermined operational condition has been satisfied), the energy storage device backup predictor 224 is configured to trigger the event log controller 268 to record a corresponding event in the SEL and/or trigger an alert controller 272 to generate an alert regarding the event. For example, the recorded event or generated alert may indicate an amount of time before the energy storage device would no longer be able to support a backup of information from the volatile memory to the non-volatile memory, a percentage reduction in usable life of the energy storage device, and/or the like. This arrangement advantageously allows for future energy storage device failures to be predicted or estimated, repairs or replacement to be made, and thus risks to be mitigated.

In a further implementation, one or more reductions in obtained energy storage device health parameters 226 are recorded as events for use in monitoring of the energy storage device. As an example, the predictor 204, while monitoring obtained energy storage device health parameters 226, ascertains whether a monitored one of the health parameters 226 is equal to or greater than a predetermined amount less than a previously monitored one of the health parameters and then record a corresponding event when the energy storage device backup predictor 224 ascertains as much. For example, each 5% reduction in an SOH parameter 232 is recorded as an event. While the controllers 248, engines 218, and storage 230 are illustrated in FIG. 2 as being part of the BMC 204, one or more of the controllers 248, engines 218, and/or storage 230 may be implemented outside of the BMC 204.

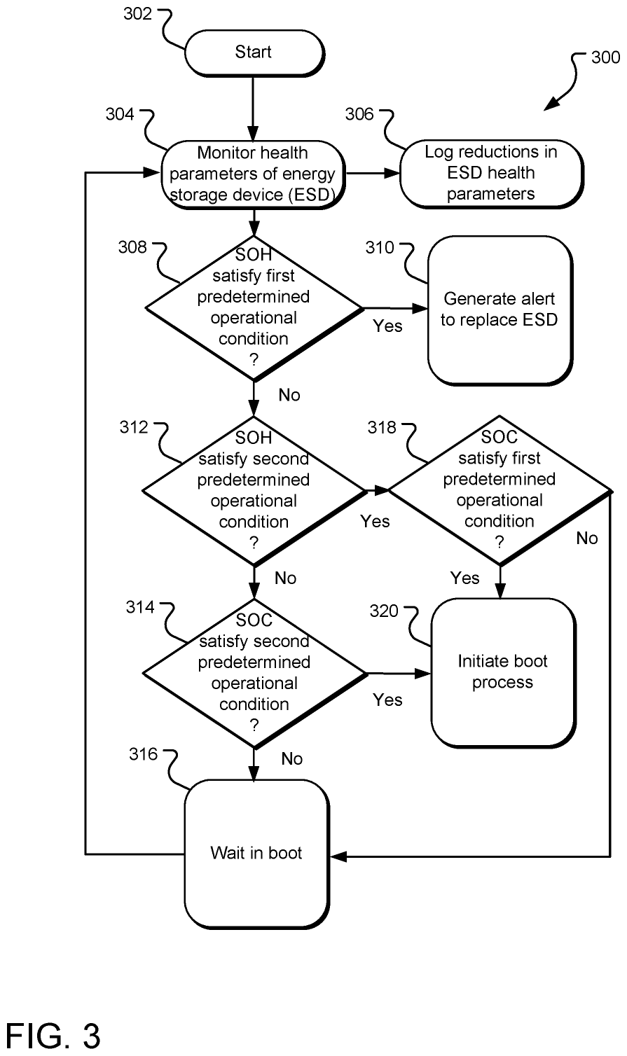

FIG. 3 illustrates an example flow of operations for selectively allowing or disallowing a boot operation depending on the degree to which (or whether) an energy storage device can support a backup of information on a volatile memory device to a non-volatile memory device. After a start operation 302, a monitoring operation 304 monitors health parameters of an energy storage device and a logging operation 306 may log reductions in monitored energy storage device health parameters. For example, the monitoring operation 304 includes obtaining and recording SOC and SOH parameters for the energy storage device after every predetermined period of time (e.g., after every one second or the like). Also for example, the logging operation 306 includes logging an event every time the SOH parameter falls 5% or more below a previously recorded SOH parameter.

In any case, a first SOH parameter satisfying query 308 queries whether an obtained SOH parameter satisfies a first predetermined operational condition. For example, the first predetermined operational condition may be when the obtained SOH parameter is equal to or less than a first predetermined SOH parameter level (e.g., 55%). As discussed herein, predetermined operational conditions are in some implementations dependent on one or more specific memory parameters (e.g., capacity, amount of stored information, etc.), where the first predetermined SOH parameter level for a first set of memory parameters may be different than the first predetermined SOH parameter level for a second set of memory parameters. Responsive to a positive answer to the query 308, an alert generation operation 310 generates an alert to replace the energy storage device as it may be surmised that an attempted backup operation may fail.

Response to a negative answer to the query 308, a second SOH parameter satisfying query 312 queries whether the obtained SOH parameter satisfies a different second predetermined operational condition. For example, the second predetermined operational condition may be when the obtained SOH parameter is less than a second predetermined SOH parameter level (e.g., 70%) that is greater than the first predetermined SOH parameter level.

Responsive to a positive answer to the query 312, a first SOC parameter satisfying query 314 queries whether an obtained SOC parameter (e.g., obtained in conjunction with the obtained SOH parameter) satisfies a first predetermined operational condition. For example, the first predetermined operational condition may be when the obtained SOC parameter is greater than a first predetermined SOC parameter level (e.g., 95%). In one implementation responsive to the positive answer to the query 312, it can be surmised that an attempted backup may fail and thus an alert may be generated (e.g., and sent up to a data center fabric) to follow a standard return merchandise authorization (RMA) process for the energy storage device.

Responsive to a positive answer to the query 314, an initiating operation 316 initiates a boot process (e.g., to load an OS into memory). Responsive to a negative answer to the query 314, a waiting operation 318 cycles back to the monitoring operation 304.

Responsive to a negative answer to the query 312, a second SOC parameter satisfying query 320 queries whether the obtained SOC parameter satisfies a second predetermined operational condition. For example, the second predetermined operational condition may be when the obtained SOC parameter is greater than a second predetermined SOC parameter level (e.g., 85%) that is less than the first predetermined SOC parameter level. Responsive to a positive answer to the query 320, the initiating operation 316 initiates the boot process. Responsive to a negative answer to the query 320, the waiting operation 318 cycles back to the monitoring operation 304.

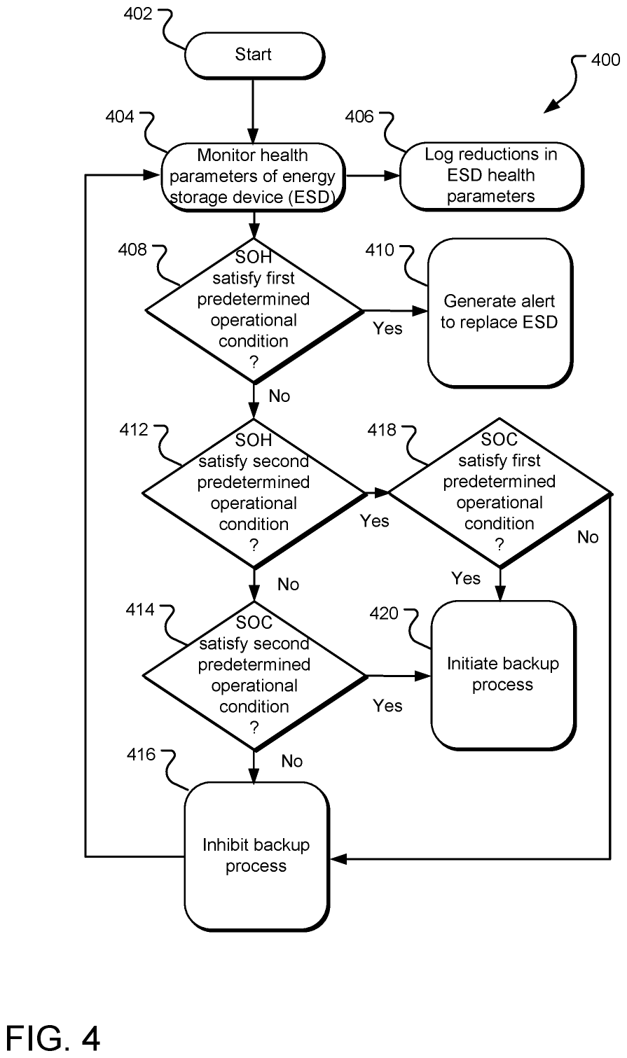

FIG. 4 illustrates an example flow of operations for selectively allowing or disallowing a backup operation depending on the degree to which (or whether) an energy storage device can support a backup of information on a volatile memory device to a non-volatile memory device. Operations 402, 404, 406, 408, 410, 412, 414, and 420 in FIG. 4 may be the same as operations 302, 304, 306, 308, 310, 312, 314, and 320 in FIG. 3, respectively. Initiating operation 416 includes initiating a backup process of information from volatile memory to non-volatile memory. Inhibiting operation 418 includes inhibiting a backup process of information from volatile memory to non-volatile memory.

The disclosed technologies reflect an improvement in the functioning of computing devices by actively identifying when current energy storage device capacity may and may not support backups of information from volatile to non-volatile memory in various situations and intelligently controlling corresponding actions in a manner that extends the usable life of computing devices and allows for scheduled repairs of energy storage devices before hard failure occurs. Specifically, by monitoring obtained energy storage device health parameters and memory parameters and determining whether the obtained energy storage device health parameters satisfy predetermined operational conditions that are specifically based on the obtained memory parameters, such above technological improvements can be achieved.

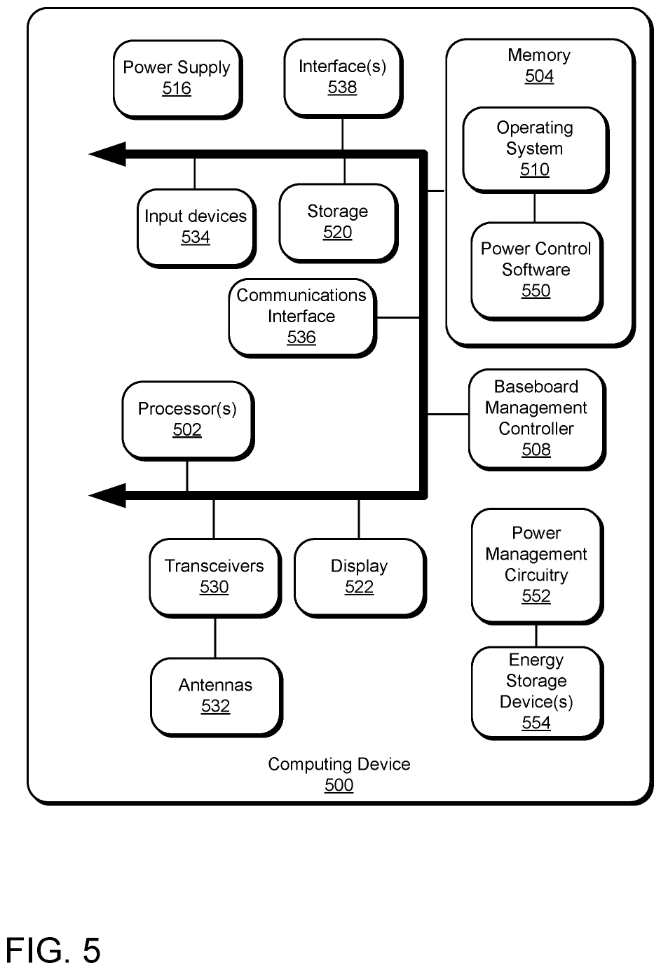

FIG. 5 illustrates an example computing device 500 for use in providing operational control of the computing device using monitored energy storage device health parameters. The computing device 500 may be a client device, such as a laptop, mobile device, desktop, tablet, or a server/cloud device. The computing device 500 includes one or more processor(s) 502, and a memory 504. The memory 504 generally includes both volatile memory (e.g., RAM) and non-volatile memory (e.g., flash memory). An OS 510 resides in the memory 504 and is executed by the processor(s) 502.

In an example computing device 500, as shown in FIG. 5, one or more modules or segments, such as power control software 550, application modules, and other modules, are loaded into the operating system 510 on the memory 504 and/or storage 520 and executed by processor(s) 502. The storage 520 may store energy storage device characteristics, charge levels, SOH and SOC parameters, system load requirements, and other data and be local to the computing device 500 or may be remote and communicatively connected to the computing device 500.

The computing device 500 includes a power supply 516 powered by one or more power sources and which provides power to other components of the computing device 500. The computing device 500 also includes one or more energy storage devices 554 (e.g., batteries) that may be balanced by power management circuitry 552 to provide current to one or more system loads in the computing device 500. The one or more energy storage devices 554 may be charged by power supply 516.

The computing device also includes a baseboard management controller 508 (e.g., service processor) that is configured to monitor energy storage device health parameters of the energy storage device(s) 554 and provide operational control of memory backup operations and the like based on the monitored health parameters as discussed herein. For example, the baseboard management controller 508 may implement each of the energy storage device health monitor 220, memory status monitor 222, and energy storage device backup predictor 224 of FIG. 2 as one or more sets of computer-readable instructions encoded on one or more memory devices and executable by one or more processors.

The computing device 500 may include one or more communication transceivers 530 which may be connected to one or more antenna(s) 532 to provide network connectivity (e.g., mobile phone network, Wi-Fi®, Bluetooth®) to one or more other servers and/or client devices (e.g., mobile devices, desktop computers, or laptop computers). The computing device 500 may further include a network adapter 536, which is a type of communication device. The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard or mouse). These and other input devices may be coupled to the server by one or more interfaces 538 such as a serial port interface, parallel port, or universal serial bus (USB). The computing device 500 may further include a display 522, such as a touch screen display.

The computing device 500 may include a variety of tangible processor-readable storage media and intangible processor-readable communication signals. Tangible processor-readable storage can be embodied by any available media that can be accessed by the computing device 500 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 100. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled, and/or interpreted programming language.

An example method of controlling a backup operation of a volatile memory device on a computing device includes monitoring one or more health parameters of an energy storage device in the computing device, determining whether the one or more health parameters satisfy a predetermined operational condition, executing the backup operation when the one or more health parameters are determined to satisfy the predetermined operational condition, and inhibiting execution of the backup operation when the one or more health parameters are determined to not satisfy the predetermined operational condition.

In another example method of any preceding method, the monitoring includes querying a register in a power supply unit of the computing device for the one or more health parameters.

Another example method of any preceding method includes querying a BIOS unit for a storage capacity of the volatile memory device, wherein the predetermined operational condition is based on the storage capacity.

Another example method of any preceding method includes writing an event to a system event log responsive to determining that the one or more health parameters do not satisfy the predetermined operational condition.

Another example method of any preceding method includes writing an event to system event log responsive to the monitoring.

Another example method of any preceding method includes ascertaining, during the monitoring, that a monitored one of the one or more health parameters is equal to or greater than a predetermined amount less than a previously monitored one of the one or more health parameters, where the writing is responsive to the ascertaining.

In another example method of any preceding method, the executing includes copying data from the volatile memory device to a non-volatile memory device.

An example computing device includes a volatile memory device, a power supply unit that includes an energy storage device, an energy storage device health monitor that monitors one or more health parameters of the energy storage device, and an energy storage device backup predictor. The energy storage device backup predictor determines whether the one or more health parameters satisfy a predetermined operational condition, initiates execution of a backup operation of the volatile memory device when the one or more health parameters are determined to satisfy the predetermined operational condition, and initiates inhibition of execution of the backup operation of the volatile memory device when the one or more health parameters are determined to not satisfy the predetermined operational condition.

In another example computing device of any preceding computing device, the energy storage device health monitor monitors by querying a register in the power supply unit for the one or more health parameters.

Another example computing device of any preceding computing device includes a memory status monitor that queries a basic input/output system (BIOS) unit for a storage capacity of the volatile memory device, wherein the predetermined operational condition is based on the storage capacity.

Another example computing device of any preceding computing device includes an event log controller that writes an event to a system event log responsive to determining that the one or more health parameters do not satisfy the predetermined operational condition.

Another example computing device of any preceding computing device includes an event log controller that writes an event to system event log responsive to the monitoring.

In another example computing device of any preceding computing device, the energy storage device backup predictor ascertains, during the monitoring, that a monitored one of the one or more health parameters is equal to or greater than a predetermined amount less than a previously monitored one of the one or more health parameters, where the event log controller writes responsive to the ascertaining.

In another example computing device of any preceding computing device, the storage device backup predictor initiates the execution by triggering a backup controller to copy data from the volatile memory device to a non-volatile memory device.

An example tangible processor-readable storage media embodied with instructions for executing on one or more processors and circuits of a device a process for controlling a backup operation of a volatile memory device on a computing device is disclosed, where the process includes monitoring one or more health parameters of an energy storage device in the computing device, determining whether the one or more health parameters satisfy a predetermined operational condition, executing the backup operation when the one or more health parameters are determined to satisfy the predetermined operational condition, and inhibiting execution of the backup operation when the one or more health parameters are determined to not satisfy the predetermined operational condition.

In another example tangible processor-readable storage media of any preceding tangible processor-readable storage media, the monitoring includes querying a register in a power supply unit of the computing device for the one or more health parameters.

Another example tangible processor-readable storage media of any preceding tangible processor-readable storage media includes querying a basic input/output system (BIOS) unit for a storage capacity of the volatile memory device, where the predetermined operational condition is based on the storage capacity.

Another example tangible processor-readable storage media of any preceding tangible processor-readable storage media includes writing an event to a system event log responsive to determining that the one or more health parameters do not satisfy the predetermined operational condition.

Another example tangible processor-readable storage media of any preceding tangible processor-readable storage media includes writing an event to system event log responsive to the monitoring.

In another example tangible processor-readable storage media of any preceding tangible processor-readable storage media, the executing includes copying data from the volatile memory device to a non-volatile memory device.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of controlling a backup operation of a volatile memory device on a computing device, the method comprising:
monitoring one or more health parameters of an energy storage device in the computing device;
determining whether the one or more health parameters satisfy a predetermined operational condition;
executing the backup operation when the one or more health parameters are determined to satisfy the predetermined operational condition; and
inhibiting execution of the backup operation when the one or more health parameters are determined to not satisfy the predetermined operational condition.

2. The method of claim 1, wherein the monitoring includes:
querying a register in a power supply unit of the computing device for the one or more health parameters.

3. The method of claim 1, further including:
querying a basic input/output system (BIOS) unit for a storage capacity of the volatile memory device, wherein the predetermined operational condition is based on the storage capacity.

4. The method of claim 1, further including:
writing an event to a system event log responsive to determining that the one or more health parameters do not satisfy the predetermined operational condition.

5. The method of claim 1, further including:
writing an event to system event log responsive to the monitoring.

6. The method of claim 5, further including:
ascertaining, during the monitoring, that a monitored one of the one or more health parameters is equal to or greater than a predetermined amount less than a previously monitored one of the one or more health parameters, wherein the writing is responsive to the ascertaining.

7. The method of claim 1, wherein the executing includes:
copying data from the volatile memory device to a non-volatile memory device.

8. A computing device, comprising:
a volatile memory device;
a power supply unit that includes an energy storage device;
an energy storage device health monitor that monitors one or more health parameters of the energy storage device; and
an energy storage device backup predictor that determines whether the one or more health parameters satisfy a predetermined operational condition, initiates execution of a backup operation of the volatile memory device when the one or more health parameters are determined to satisfy the predetermined operational condition, and initiates inhibition of execution of the backup operation of the volatile memory device when the one or more health parameters are determined to not satisfy the predetermined operational condition.

9. The computing device of claim 8, wherein the energy storage device health monitor monitors by
querying a register in the power supply unit for the one or more health parameters.

10. The computing device of claim 8, further including a memory status monitor that queries a basic input/output system (BIOS) unit for a storage capacity of the volatile memory device, wherein the predetermined operational condition is based on the storage capacity.

11. The computing device of claim 8, further including an event log controller that writes an event to a system event log responsive to determining that the one or more health parameters do not satisfy the predetermined operational condition.

12. The computing device of claim 8, further including an event log controller that writes an event to system event log responsive to the monitoring.

13. The computing device of claim 12, wherein the energy storage device backup predictor ascertains, during the monitoring, that a monitored one of the one or more health parameters is equal to or greater than a predetermined amount less than a previously monitored one of the one or more health parameters, wherein the event log controller writes responsive to the ascertaining.

14. The computing device of claim 8, wherein the energy storage device backup predictor initiates the execution by triggering a backup controller to copy data from the volatile memory device to a non-volatile memory device.

15. One or more tangible processor-readable storage media embodied with instructions for executing on one or more processors and circuits of a device a process for controlling a backup operation of a volatile memory device on a computing device, the process comprising:
monitoring one or more health parameters of an energy storage device in the computing device;
determining whether the one or more health parameters satisfy a predetermined operational condition;
executing the backup operation when the one or more health parameters are determined to satisfy the predetermined operational condition; and
inhibiting execution of the backup operation when the one or more health parameters are determined to not satisfy the predetermined operational condition.

16. The one or more tangible processor-readable storage media of claim 15, wherein the monitoring includes:
querying a register in a power supply unit of the computing device for the one or more health parameters.

17. The one or more tangible processor-readable storage media of claim 15, wherein the process further includes:
querying a basic input/output system (BIOS) unit for a storage capacity of the volatile memory device, wherein the predetermined operational condition is based on the storage capacity.

18. The one or more tangible processor-readable storage media of claim 15, wherein the process further includes:
writing an event to a system event log responsive to determining that the one or more health parameters do not satisfy the predetermined operational condition.

19. The one or more tangible processor-readable storage media of claim 15, wherein the process further includes:
writing an event to system event log responsive to the monitoring.

20. The one or more tangible processor-readable storage media of claim 15, wherein the executing includes:
copying data from the volatile memory device to a non-volatile memory device.
